(19) United States
(12) Patent Application Publication
(10) Pub. No.: US 2026/0124779 A1
(43) Pub. Date: May 7, 2026

(54) MOUNTING DEVICE FOR MOUNTING A SUPPORTING BOARD IN A FLATBED DIE CUTTING MACHINE, SUPPORTING BOARD AND A FLATBED DIE CUTTING MACHINE

(71) Applicant: BOBST MEX SA, Mex (CH)

(72) Inventors: Paul HORNICK, Vallorbe (CH); David GENTIL, L’Auberson (CH)

(73) Assignee: BOBST MEX SA, Mex (CH)

(21) Appl. No.: 19/118,433

(22) PCT Filed: Oct. 20, 2023
(86) PCT No.: PCT/EP2023/079348

§ 371 Date: Apr. 4, 2025

(30) Foreign Application Priority Data
Oct. 31, 2022 (EP) 22204630.2

(51) Int. Cl. B26D 7/20

(52) U.S. Cl. CPC B26D 7/20

(57) ABSTRACT

The invention relates to a mounting device (10) for mounting a supporting board (12) in a flatbed die cutting machine (2), having a support, first and second adjustment units (30), and an adjustable abutment unit (32), the adjustment units (30) and the abutment unit (32) being arranged spaced from each other at the support (11) for receiving the supporting board (12) in a position which is adjustable with respect to the support (11), the mounting device (10) having actuators (46, 56) associated with the adjustment units (30) and the abutment unit (32). The invention further relates to a supporting board (12) for a flatbed die cutting machine (2), having first and second engagement structures (14) adapted for cooperating with first and second adjustment units (30) of a mounting device (10) as defined in any of the preceding claims, and an abutment structure (20) spaced from the first and second engagement structures (14), the engagement structures (14) being adapted for positioning the supporting board (12) in a first direction while the abutment structure (20) is adapted for positioning the supporting board (12) in a second direction which is perpendicular to the first direction. The invention finally relates to a flatbed die cutting machine (2), having a mounting device (10) as defined above and a supporting board (12) as defined above.

### CROSS-REFERENCE TO RELATED APPLICATION(S)

This application is a National Stage Application under 35 U.S.C. § 371 of International Application No. PCT/EP2023/079348, filed Oct. 20, 2023, which claims priority to European Application No. 22204630.2, filed on Oct. 31, 2022, the entireties of which are incorporated herein by reference.

The present invention refers to a mounting device for mounting a supporting board in a flatbed die cutting machine, a supporting board and a flatbed die cutting machine.

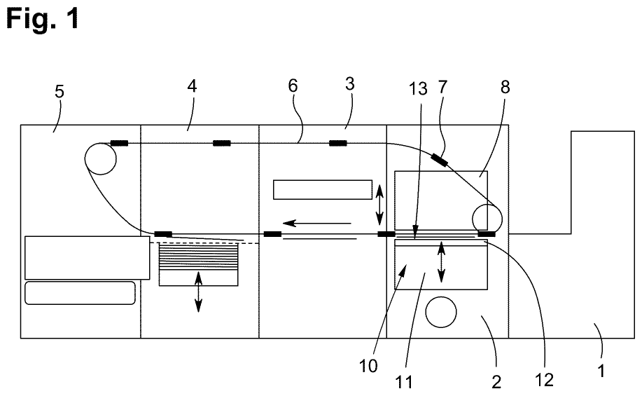

A die cutting machine processes sheets of cardboard. This will be briefly explained with respect to FIG. 1.

The cardboard enters in an introduction station 1, is gripped and transported through the die cutting machine 2 (often also referred to as “platen press”), a waste ejection station 3, and a blanking station 4.

At the die cutting machine 2, blanks are cut from the sheet material and are possibly provided with folding creases. At the waste ejection station 3, waste material is separated from the sheet material. At the blanking station 4, the blanks are separated from the cardboard sheet. At the ejection station 5, the remainder of the sheet material is ejected. The sheet material is transported throughout the stations with a chain drive 6 which has a plurality of gripper bars 7

The die cutting machine 2 press serves two purposes: to cut the blank in the sheet and to create creasing lines (or even embossing some shapes). A creasing line is a compression of the cardboard where the cardboard will be folded to create a box.

To create a creasing line, the die cutting machine has a fixed upper tool 8 which carries some knives/rules on a tooling board to cut or crease the cardboard. The die cutting machine has also a lower tool that moves up and down, with the lower tool having a mounting device 10 which carries a supporting board 12 and a thin plate 13 with some slots that are aligned with the creasing rules of the upper plate. The thin plate is fixed to the supporting board either by screws or by a quick lock mechanism. Once mounted on the supporting board, the thin plate 13 position is fixed on the supporting board. The tooling board of the upper tool 8 and the thin plate of the lower tool must be changed for every production job. To change the thin plate, the supporting board and thin plate assembly is extracted from the machine, the thin plate is removed and replaced by a new one, and the supporting board and thin plate assembly is put back in the machine.

In the prior art, the position of the supporting board 12 with respect to the tooling board is adjusted by using adjustment screws which are provided for a manual adjustment of the position of the supporting board 12 with respect to the mounting device 10.

The object of the invention is to make the adjustment of the supporting board easier.

To solve this object, the invention provides a mounting device for mounting a supporting board in a flatbed die cutting machine, having a support, first and second adjustment units, and an adjustable abutment unit, the adjustment units and the abutment unit being arranged spaced from each other at the support for receiving the supporting board in a position which is adjustable with respect to the support, the mounting device having actuators associated with the adjustment units and the abutment unit. The combination of the two adjustment units and the abutment unit allows adjusting the position of the supporting board both in a longitudinal direction and a transverse direction when defining the direction of travel of the sheets as the longitudinal direction. Further, a rotational adjustment is possible.

Using electric motors as the actuators allows making the adjustment in a convenient manner, requiring only electric cable for providing the necessary energy to the actuators.

In one embodiment, the adjustment units each have a drive element which is translationally displaceable with respect to the support. The drive element is a mechanically simple element for defining the position of the supporting board with respect to the mounting device.

The drive element can be a screw on which a drive nut is arranged which his driven by one of the actuators. This type of linear drive allows transforming the motion provided by the actuator into the translational movement in a very convenient manner.

In one embodiment, the abutment unit comprises a wedge which is translationally displaceable. A wedge is a mechanically simple element which allows adjusting the position of the supporting board in a direction which is perpendicular to the direction of displacement of the wedge.

The wedge can be arranged on a screw which is driven by one of the actuators. Here as well, linear drive is formed which allows transforming the motion provided by the actuator into the translational movement in a very convenient manner.

Preferably, a locking unit is provided which is associated with the abutment unit for mechanically locking the supporting board to the mounting device.

The locking unit can have a locking lever which is rotationally displaceable between a mounting position and a locking position. Using a pivotable locking lever is a mechanically simple solution which does not require sophisticated guides on the mounting device.

A pneumatic actuator can be associated with the locking lever so that the locking lever can be biased with a locking force while still allowing for some flexibility or displaceability of the locking lever because of the gas buffer present within the pneumatic actuator.

The above object is also solved by means of a supporting board for a flatbed die cutting machine, having first and second engagement structures adapted for cooperating with first and second adjustment units of a mounting device as defined in any of the preceding claims, and an abutment structure spaced from the first and second engagement structures, the engagement structures being adapted for positioning the supporting board in a first direction while the abutment structure is adapted for positioning the supporting board in a second direction which is perpendicular to the first direction. The engagement structures and the abutment structure cooperate with the adjustment units and the abutment unit so as to allow for an adjustment of the supporting board in a translational manner both in a longitudinal and a transverse direction, and rotationally around an axis which is perpendicular to the plane of the supporting board.

The engagement structures can have a fork-like shape, with both engagement structures being open at the same side of the supporting board. This shape of the engagement structures allows for a reliable cooperation with the adjustment units of the mounting device while at the same time allowing the supporting board to be placed at the mounting device in a very simple manner, namely by transversely pushing the engagement structures onto the adjustment units.

The abutment structure preferably has a curved surface, the center of curvature being on the side of the supporting board which is opposite the side towards which the engagement structures are open. The curved surface forms an axis of rotation around which the supporting board can be rotated during the adjustment process, with this axis being essentially stationary during rotation of the supporting board which simplifies the adjustment process.

The supporting board preferably has a rectangular shape, with the engagement structures being at diametrically opposite positions and the abutment structure being at a position so as to form a triangle with the position of the engagement structures. This positioning of the different structures ensures a reliable and stable connection between the supporting board and the mounting device. More generally, the engagement structures are disposed on opposite sides of the supporting board. Preferably, they are disposed on each transverse side of the board. The transverse sides being the sides parallel to the longitudinal axis. The abutment structure is placed on the same side than one of the engagement structures. The configuration of the engagement structure and abutment structure preferably form a triangle. Nevertheless, the abutment structure might also be positioned at the same location as one of the engagement structure (resulting in a degenerate triangle with two merged vertices, where the abutment structure is on one of the merged vertices).

The above object is also solved with a flatbed die cutting machine, having a mounting device as defined above and a supporting board as defined above and clamped to the mounting device. Regarding the advantages, reference is made to the above comments.

Preferably, a position sensing system is provided for sensing the position of the supporting board with respect to a counter tool. This allows using a software for adjusting the position of the supporting board with respect to the tooling board, thus, to adjust the thin plate 13 position with respect to the tooling board, possibly with the aid of a camera system adapted for capturing geometric structures which are indicative of the position of the respective board and allowing for the position of the supporting board being adjusted with respect to the tooling board.

It is to be mentioned here that features and/or advantages explained for the supporting board on the one hand and the mounting device on the other hand are applicable for the supporting board and the mounting device, respectively, and also for the die cutting machine having both the mounting device and the supporting board.

The invention will now be described with reference to the enclosed drawings. In the drawings,

FIG. 1 is a schematic view of a die cutting machine,

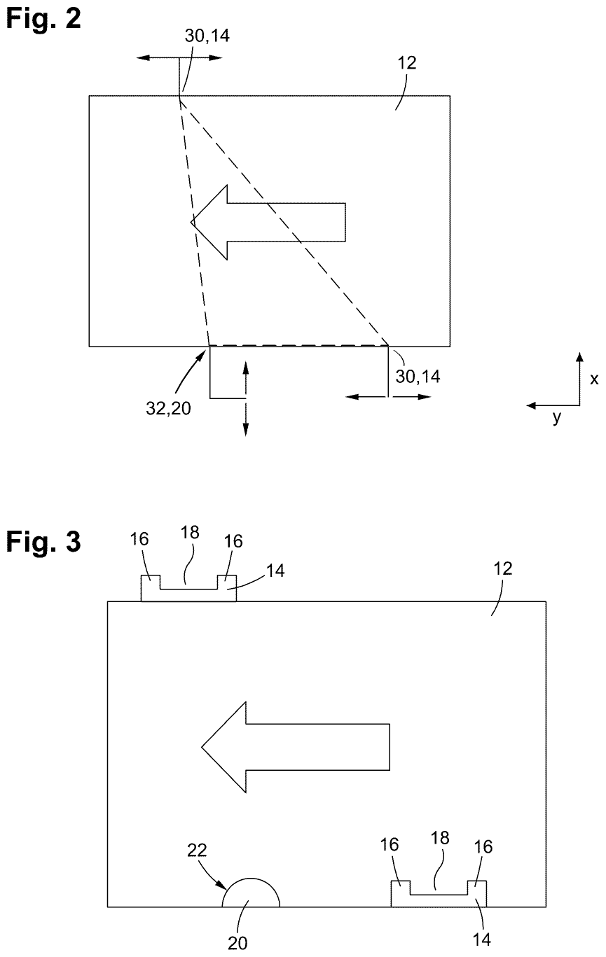

FIG. 2 is a schematic representation of a supporting board and the directions in which its position can be adjusted,

FIG. 3 is a schematic representation of the supporting board,

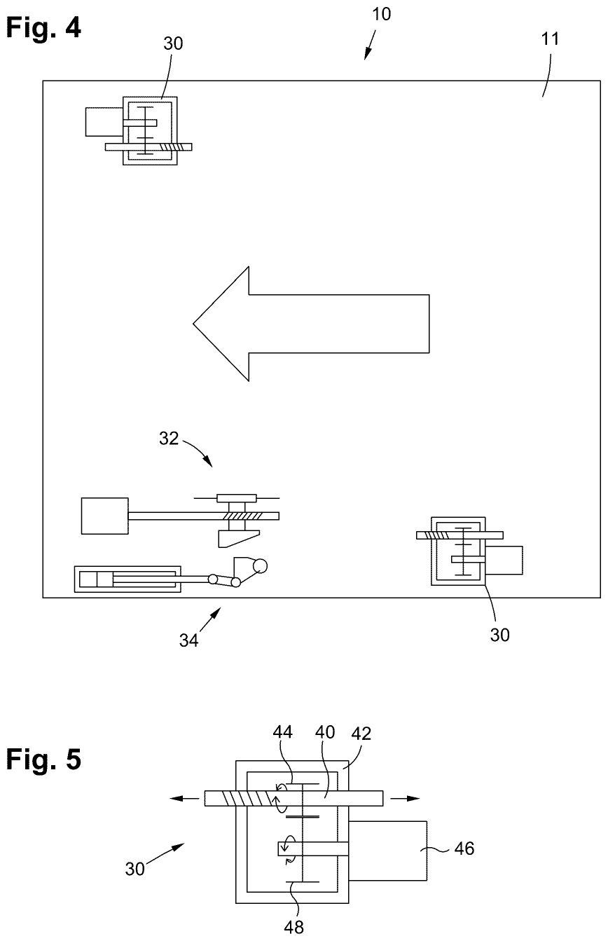

FIG. 4 is a schematic representation of a mounting device adapted for receiving the supporting board of FIG. 3,

FIG. 5 is a schematic representation of an adjustment unit used at the mounting device of FIG. 4,

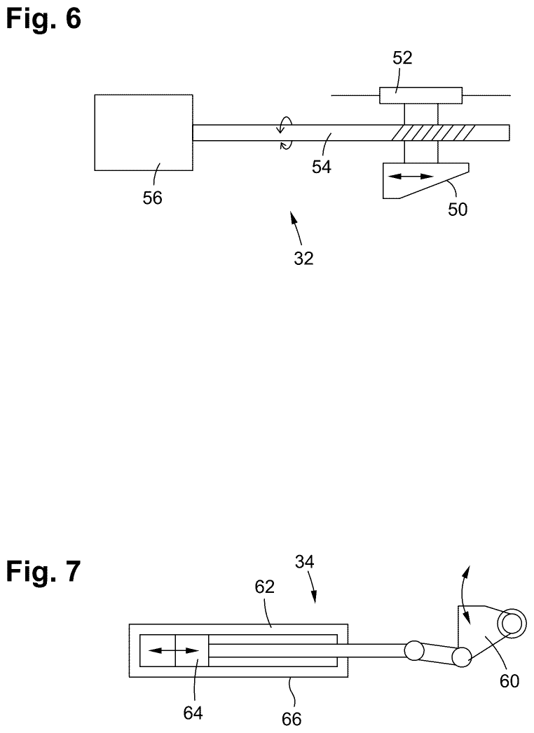

FIG. 6 is a schematic representation of an abutment unit used in the mounting device of FIG. 4,

FIG. 7 is a schematic representation of a locking unit used in the mounting device of FIG. 4,

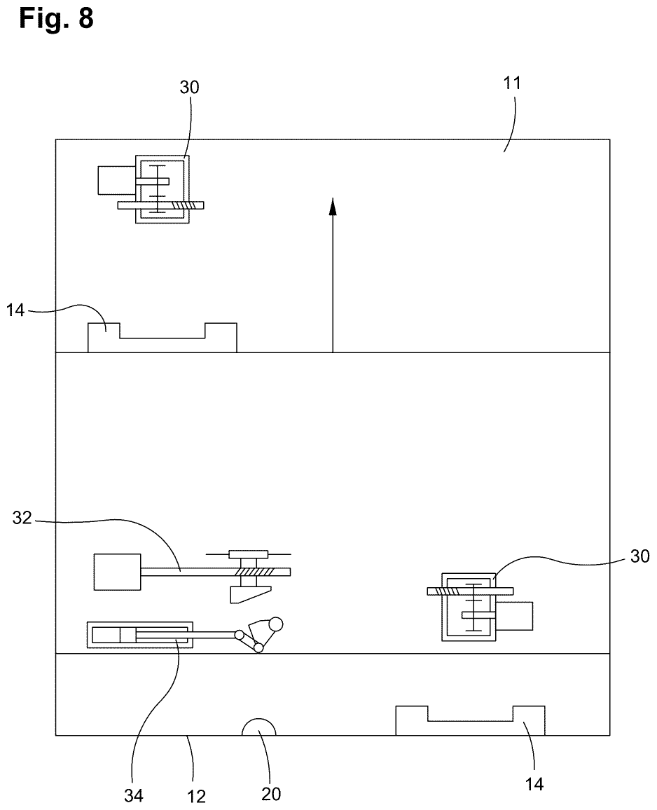

FIG. 8 shows the supporting board of FIG. 3 in an intermediate step while being mounted on the mounting device of FIG. 4, and

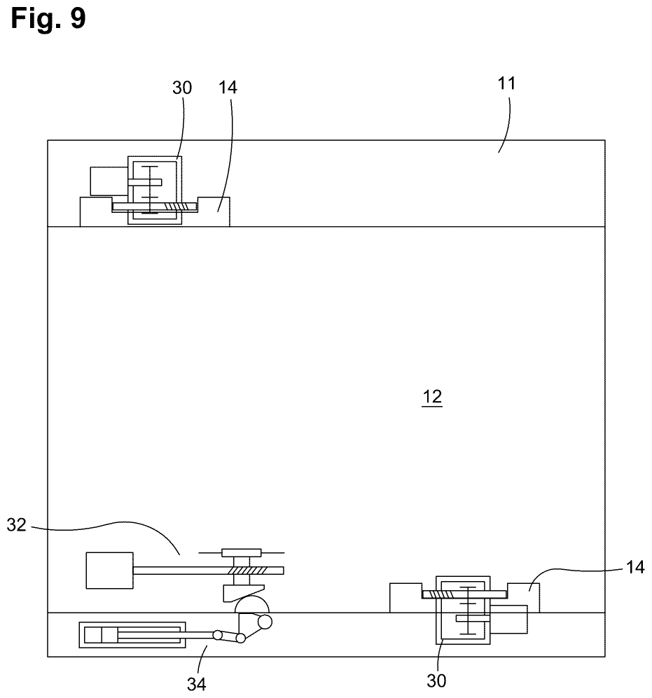

FIG. 9 is a schematic representation of the supporting board being mounted to the mounting device.

FIG. 2 schematically shows the supporting board used in the die cutting machine. The direction of travel of the sheets through the die cutting machine is here indicated with an arrow, this direction also being referred to as the longitudinal direction.

For achieving a proper position of the supporting board 12 and the thin plate 13 with respect to the upper tool of the die cutting machine, supporting board 12 has to be displaced in the longitudinal direction (along the y axis), in a transverse direction (along the x axis) and also rotated around an access which is perpendicular to the plane defined by the x axis and the y axis (thus along the z axis).

According to the invention, the adjustment is here achieved by mounting the supporting board 12 at three positions on the mounting device 10, with these three positions forming a triangle (indicated in FIG. 2 in dashed lines).

At two of the vertices of the triangle, the supporting board 12 can be adjusted with respect to the mounting device 10 in a longitudinal direction, and at the remaining vertex, the position of the supporting board 12 can be adjusted in a transverse direction with respect to the mounting device 10. Superimposing the longitudinal adjustments with the transverse adjustment in a suitable manner allows a rotational adjustment.

An embodiment of the supporting board 12 according to the invention is shown in FIG. 3.

The supporting board has two engagement structures 14 arranged at opposite sides of the supporting board 12 and spaced from each other in a longitudinal direction.

Each engagement structure 14 has a fork-like shape with two projections 16 and a free space 18 there between. Both engagement structures 14 are open at the same side of the supporting board (in FIG. 3 on the upper side).

This supporting board 12 further comprises an abutment structure 20 which is here positioned so as to form the triangle indicated in FIG. 2. Regarding the fork-like shape of the engagement structures 14, it is important to note that abutment structure 20 is arranged at the same side of the supporting board 12 as the engagement structure 14 is which is open towards the center line of the supporting board.

Abutment structure 20 has a convex surface 22 which is facing the center line of supporting board 12. In other words, the center(s) of curvature is on the side of the supporting board which is opposite to the side towards which the engagement structures are open.

In the shown embodiment, surface 22 has a constant radius, and the center of curvature is, with respect to FIG. 3, on the lower side of the supporting board while the side towards which the engagement structures 14 are open is the upper side.

In FIG. 4, mounting device 10 is schematically shown. Here again, the direction of travel of the sheets is indicated with the arrow.

Mounting device 10 has a support 11 (which is preferably the movable beam of the platen press) and two adjustment units 30 and an abutment unit 32 arranged on support 11. The supporting board 12 is placed on top of the support 11, allowing for a convenient extraction from the machine. The positions of the units 30, 32 correspond to the vertices of the triangle formed from engagement structures 14 and abutment structure 20. Thus, the units 30 coupled to the engagement structures 14 displace two of the vertices of the triangle along the longitudinal (Y) direction, thereby controlling the longitudinal position and the orientation of the supporting board 12. The unit 32 coupled to the abutment structure 20 displaces one of the vertices of the triangle along the transverse (X) direction, thereby controlling the transverse position of the board 12.

Mounting device 10 further comprises a locking unit 34 which is associated with abutment unit 32.

Adjustment unit 30 is shown in FIG. 5 in more detail.

It comprises a drive element 40 which is translationally displaceable. Drive element 40 is here a rod or a screw which is guided in a guide 42 and is held in a non-rotatable manner with respect to guide 42.

A drive nut is arranged on drive element 40 for converting a rotational movement into the translational movement of the drive element.

The drive nut can here be formed by a gear wheel 44 with an internal thread which is mounted on a thread of drive element 40 so that a rotation of gear wheel 44 is converted into a translational displacement of drive element 40.

Gear wheel 44 can be driven by means of an actuator 46 (preferably an electric motor) which drives a gear wheel 48 which meshes with gear wheel 44. A step-down gear drive can be placed between actuator 46 and gear wheel 48.

Actuator 46 can be controlled so as to displace drive element 40 to a desired position in the longitudinal direction.

Abutment unit 32 shown in FIG. 6 in more detail. It comprises a wedge 50 which is also translationally displaceable. It is mounted by means of a guiding structure 52 and engages at a screw 54 which is driven by means of an actuator 56. Here again, a step-down gear drive can be placed between actuator 56 and screw 54.

Wedge 50 can be displaced along the longitudinal direction by operating actuator 56 in one direction or the other.

Locking unit 34 is shown in FIG. 7 in more detail. It comprises a locking lever 60 which is mounted in a pivotable manner on mounting device 10. For pivoting locking lever 60 between a mounting position and a locking position, an actuator 62 is provided which is here a pneumatic actuator with a piston 64 displaceable within a cylinder 66.

As indicated above, supporting board 12 has to be changed for each new job of the die cutting machine. For mounting a new supporting board 12, it is pushed in the transverse direction onto mounting device 10 (please see FIG. 8), with the open sides of fork-shaped engagement structures 14 facing forwardly.

The supporting board 12 mounted at mounting device 10 is shown in FIG. 9.

The engagement structures 14 engage at the adjustment units 30 so that drive element 40 is received between projections 16 of engagement structure 12.

Surface 22 of abutment structure 20 abuts at wedge 50 of abutment unit 32. At the opposite, outer surface, locking lever 60 of locking unit 34 engages so as to press abutment structure 20 against abutment unit 32.

The position of supporting board 12 in the longitudinal direction is defined by adjustment structures 14 engaging at drive elements 40. With suitable operation of actuator 46, this position can be adjusted as desired.

The position of supporting board 12 in a transverse direction is defined by abutment structure 20 engaging at wedge 50. This position can be adjusted as desired by actuating actuator 56 so as to displace wedge 50 in a longitudinal direction.

Supporting board 12 can be rotated with respect to mounting device 10 by changing the position of engagement elements 40 of adjusting units 30 in a longitudinal direction, either by operating only one of actuators 46 or by operating actuators 46 in opposite directions. During a rotation, surface 22 “roles” on wedge 50, with pneumatic actuator 62 exerting a biasing force onto abutment structure 20.

By appropriately operating actuators 46 and 56 with respect to each other, the longitudinal position, the transverse position and the rotational position of supporting board 12 can be adjusted with respect to mounting device 10 in the desired manner.

An automated adjustment system can be provided which ensures the proper adjustment of supporting board 12 without manual intervention. Cameras can be used to capture geometrical structures indicative of the position of supporting board 12, and a control can be used to determine the required adjustments to be made so as to move the supporting board 12 into the desired position.

1. A mounting device for mounting a supporting board in a flatbed die cutting machine, having a support configured to carry the supporting board, first and second adjustment units, and an adjustable abutment unit, the adjustment units and the abutment unit being arranged spaced from each other at the support for receiving the supporting board in a position which is adjustable with respect to the support, the mounting device having actuators associated with the adjustment units and the abutment unit.

2. The mounting device of claim 1, wherein a locking unit is provided which is associated with the abutment unit.

3. The mounting device of claim 2, wherein the locking unit has a locking lever which is rotationally displaceable between a mounting position and a locking position.

4. The mounting device of claim 2, wherein the locking unit has a pneumatic actuator.

5. The mounting device of claim 1, wherein the actuators are electric motors.

6. The mounting device of claim 1, wherein the adjustment units each have a drive element which is translationally displaceable with respect to the support.

7. The mounting device of claim 6, wherein the drive element is a screw on which a drive nut is arranged which is driven by one of the actuators.

8. The mounting device of claim 1, wherein the abutment unit comprises a wedge which is translationally displaceable.

9. The mounting device of claim 8, wherein the wedge is arranged on a screw which is driven by one of the actuators.

10. A supporting board for a flatbed die cutting machine, having first and second engagement structures adapted for cooperating with first and second adjustment units of the mounting device of claim 1, and an abutment structure spaced from the first and second engagement structures, the engagement structures being adapted for positioning the supporting board in a first direction while the abutment structure is adapted for positioning the supporting board in a second direction which is perpendicular to the first direction.

11. The supporting board of claim 10, wherein the engagement structures have a fork-like shape, with both engagement structures being open at the same side of the supporting board.

12. The supporting board of claim 10, wherein the abutment structure has a curved surface, the center of curvature being on the side of the supporting board which is opposite the side towards which the engagement structures are open.

13. The supporting board of claim 10, wherein the supporting board has a rectangular shape, with the engagement structures being at opposite sides of the board, and with the abutment structure being on one of said sides of the board.

14. A flatbed die cutting machine, having the mounting device of claim 1, and a supporting board clamped to the mounting device,
wherein the supporting board includes first and second engagement structures adapted for cooperating with the first and second adjustment units of the mounting device, and an abutment structure spaced from the first and second engagement structures, the engagement structures being adapted for positioning the supporting board in a first direction while the abutment structure is adapted for positioning the supporting board in a second direction which is perpendicular to the first direction.

15. The flatbed die cutting machine of claim 14, wherein the supporting board carries a thin plate comprising at least one slot, the machine comprising and wherein a position sensing system is provided for sensing the position of the thin plate with respect to a counter tool.
